(19) United States
(12) Patent Application Publication
(10) Pub. No.: US 2024/0303712 A1
(43) Pub. Date: Sep. 12, 2024

(54) TOUCH ANALYTICS-DRIVEN BUYING PATTERN DETECTION SYSTEM FOR BEHAVIORAL CAUSAL ANALYSIS

(71) Applicant: Kyndryl, Inc., New York, NY (US)

(72) Inventors: Pritpal S. Arora, Bangalore (IN); Mouleswara Reddy Chintakunta, Allagadda (IN)

(21) Appl. No.: 18/117,972

(22) Filed: Mar. 6, 2023

(51) Int. Cl. G06Q 30/0601

(52) U.S. Cl. CPC G06Q 30/0629

(57) ABSTRACT

A computer-implemented method, in accordance with one embodiment, includes collecting touch data from one or more touch sensors coupled to a first product, the one or more touch sensors being configured to indicate when a human touches the one or more touch sensors and/or first product. Product vector information about the first product is received. Classification on the touch data and product vector information is performed using a hierarchical multilabel classification system for assigning the touch data to predefined patterns for each level of a classifier used by the hierarchical multilabel classification system. Features of a second product, e.g., a touch vector and a touch pattern, are transformed into a second feature vector. A featurewise difference detection is performed on the feature vectors to calculate a difference in distribution for features of the products to generate and output a caption indicative of the differences between the products.

### BACKGROUND

The present invention relates to touch analytics, and more specifically, this invention relates to using touch analytics to analyze and characterize buying patterns.

Brick and mortar shops offer products to customers, usually in a manner that allows users to touch and examine actual physical specimens of the products. However, the state of the art currently lacks ways to adequately gauge a customer's interest in a product that the customer has physically handled. Moreover, the state of the art is devoid of characterizing a customer's interaction with a specimen to determine things like whether the customer actually then purchases the product, why the customer did not purchase the product, etc.

### SUMMARY

A computer-implemented method, in accordance with one embodiment, includes collecting touch data from one or more touch sensors coupled to a product, the one or more touch sensors being configured to indicate when a human touches the one or more touch sensors and/or product. Product vector information about the product is received. Classification on the touch data and product vector information is performed using a hierarchical multilabel classification system for assigning the touch data to predefined patterns for each level of a classifier used by the hierarchical multilabel classification system. The method further includes transforming features of the first product into a first feature vector, the features of the first product including the patterns.

Features of a second product are transformed into a second feature vector, the features of the second product including at least a touch vector and a touch pattern derived at least in part from data collected by a touch sensor coupled to the second product. A featurewise difference detection is performed on the feature vectors to calculate a difference in distribution for features of the first and second products. A representation of the calculated difference in distribution for features of the first and second products is processed to create a difference vector for generating a caption indicative of the differences between the first and second products. The caption is output.

A computer program product, in accordance with one embodiment, includes a computer readable storage medium having program instructions embodied therewith, the program instructions executable by a computer to cause the computer to perform the foregoing method.

A system, in accordance with one embodiment, includes a hardware processor and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a network architecture, in accordance with one embodiment of the present invention.

FIG. 2 is a diagram of a representative hardware environment that may be associated with the servers and/or clients of FIG. 1, in accordance with one embodiment of the present invention.

FIG. 3 is a diagram of a pattern detection system for enabling root cause analytics for a product, in accordance with one embodiment.

FIG. 4 is a flowchart of a method, in accordance with one embodiment of the present invention.

FIG. 5 is a diagram of a system for performing root cause analytics for a product, in accordance with one embodiment.

FIG. 6 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using touch analytics to analyze and characterize buying patterns.

In one general embodiment, a computer-implemented method includes collecting touch data from one or more touch sensors coupled to a product, the one or more touch sensors being configured to indicate when a human touches the one or more touch sensors and/or product. Product vector information about the product is received. Classification on the touch data and product vector information is performed using a hierarchical multilabel classification system for assigning the touch data to predefined patterns for each level of a classifier used by the hierarchical multilabel classification system. The method further includes transforming features of the first product into a first feature vector, the features of the first product including the patterns. Features of a second product are transformed into a second feature vector, the features of the second product including at least a touch vector and a touch pattern derived at least in part from data collected by a touch sensor coupled to the second product. A featurewise difference detection is performed on the feature vectors to calculate a difference in distribution for features of the first and second products. A representation of the calculated difference in distribution for features of the first and second products is processed to create a difference vector for generating a caption indicative of the differences between the first and second products. The caption is output.

In another general embodiment, a computer program product includes a computer readable storage medium having program instructions embodied therewith, the program instructions executable by a computer to cause the computer to perform the foregoing method.

In another general embodiment, a system includes a hardware processor, and logic integrated with the processor, executable by the processor, or integrated with and executable by the processor, the logic is configured to perform the foregoing method.

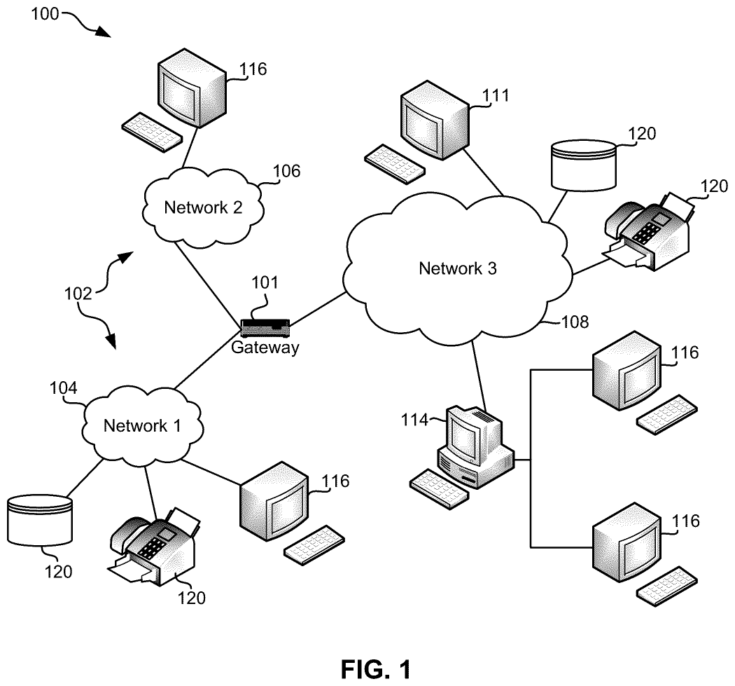

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX® system which emulates an IBM® z/OS® environment (IBM and all IBM-based trademarks and logos are trademarks or registered trademarks of International Business Machines Corporation and/or its affiliates), a UNIX® system which virtually hosts a known operating system environment, an operating system which emulates an IBM® z/OS® environment, etc. This virtualization and/or emulation may be enhanced through the use of VMware® software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

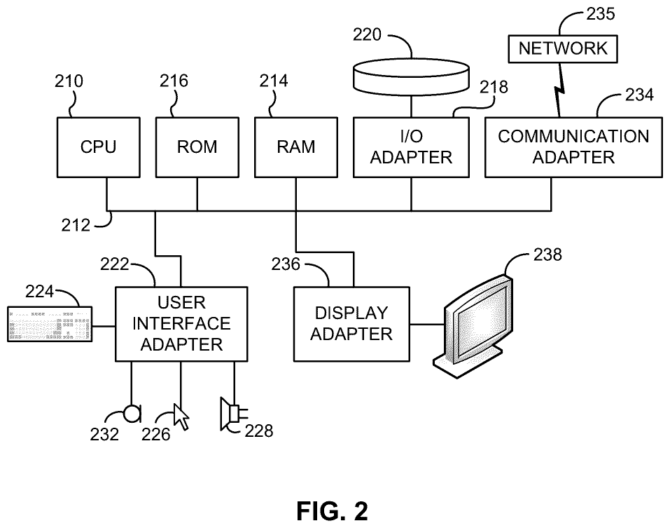

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a macOS®, a UNIX® OS, etc. It will be appreciated that a preferred embodiment may also be implemented on platforms and operating systems other than those mentioned. A preferred embodiment may be written using extensible Markup Language (XML), C, and/or C++ language, or other programming languages, along with an object oriented programming methodology. Object oriented programming (OOP), which has become increasingly used to develop complex applications, may be used.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Various embodiments of the present invention use touch analytics for a variety of practical applications, including, but not limited to:
detecting buying patterns;
performing behavioral causal analysis, e.g., for identifying consumer behaviors for buy/no-buy decisions;
enabling real-time data-driven decisions on product warehousing, stocking, pricing with consumer pattern identifications;
summarizing monthly demands and inventory requirements of end-products at a shop level, a geographical area level, etc.;
correlating geo-wise views to identify gaps vs. actual buying patterns (e.g., gaps of touch analytics vs. buy patterns);
building process behavior patterns and correlations of touch analytics and buying patterns;
deriving root cause analytics and psychological patterns on gaps of products not sold by correlating factors such as time-ranges, geo-spreads, inventories pricing factors, process behavior tags, etc. to sales data;
performing identity categorization of patterns that a given product will fall into, e.g., research buying (one who researches before buying), impulsive buying (one who does not spend much time handling a product), see vs. buy, influential and time patterns);
identifying causes of impulsive product gazing vs. actual buying patterns to firm up stocking and inventory, warehouse decisions, product feature decisions, etc.;
other applications described herein; and/or
applications that would become apparent to one skilled in the art upon reading the present disclosure.

The touch analytics are preferably based on output from one or more touch sensors. Preferred embodiments utilize touch sensors of known type that are coupled to physical products, e.g., specimens of products for sale, in brick and mortar shops to detect what consumers are buying, tending to buy, their interests and likes. Data from the touch sensors may be collected at any point, e.g., while the product is on the shelf, at point of sale, etc. Communication with the touch sensors for data retrieval may be wireless or wired.

In general, a touch sensor is an electronic sensor used in detecting, and in some cases recording, physical touch of the sensor and/or the product to which it is coupled. Touch sensors are small and are preferably low cost. Touch sensors may be tactile sensors that detect a physical touch; proximity sensors that detect proximity of a body part, e.g., within 10 cm thereof or using light; etc.

In some approaches, capacitive touch sensors may be used. Capacitive touch sensors measure touch based on electrical disturbance from a change in capacitance.

In other approaches, resistive touch sensors may be used. Resistive touch sensors measure touch through responding to the pressure applied to their surface. A typical resistive touch sensor includes two conductive layers and a non-conductive separator. Unlike capacitive touch sensors, resistive touch sensors are typically not multi-touch compatible.

Further approaches may use infrared touch sensors that measure touch by detecting whether an LED beam is broken or changed when an object (e.g., finger) makes contact with the beam. Infrared touch sensors are typically longer lasting and insensitive to pressure (similar to capacitive touch sensor).

Yet other approaches may use surface acoustic wave (SAW) touch sensors. SAW touch sensors measure the disturbance of ultrasonic waves sent across the surface of an outer layer, usually of glass. SAW touch sensors typically include a piezoelectric crystal attached to a glass layer.

One or more touch sensors may be positioned anywhere on the product, product packaging, etc. Preferably, touch sensors are placed in locations most likely to be touched.

Further approaches may use a movement detector that includes a gyroscope to detect movement of the product.

Note also that combinations of such sensors may be deployed, e.g., on a same product.

Touch analytics may include information such as touch span, e.g., the length of time a customer handled a product before setting it back down; repeat touches, e.g., how many times customers touched the product; etc. Any other type of touch analytics that would become apparent to one skilled in the art upon reading the present disclosure may be used in various embodiments, including known techniques for touch analytics.

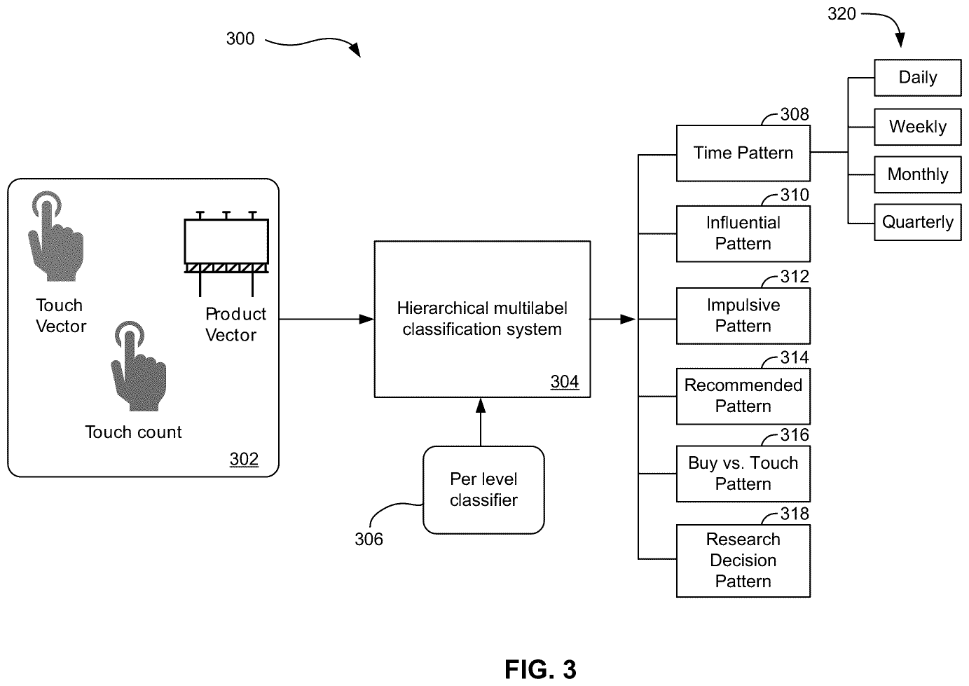

FIG. 3 depicts a pattern detection system 300 for enabling root cause analytics for a product, in accordance with one embodiment. As an option, the present system 300 may be implemented in conjunction with features from any other embodiment listed herein, such as those described with reference to the other FIGS. Of course, however, such system 300 and others presented herein may be used in various applications and/or in permutations which may or may not be specifically described in the illustrative embodiments listed herein. Further, the system 300 presented herein may be used in any desired environment.

The system may be used to detect patterns corresponding to touch of products that sold more than other similar products, as well as to detect patterns corresponding to touch of products that did not sell as well. The patterns may in turn be used to understand user behavior as it pertains to the products, so that better decisions can be made regarding what to do with the products. For example, reasons for one product selling better than another may be deduced from the patterns output by the system 300. The reasons in turn can be used to adjust parameters of the product, e.g., where it is placed in the shop, the marketing message adjacent the product, price, shelf life, which features to enhance, etc.

As shown, the system includes a data module 302 that collects touch data from touch sensors. Any type of information that would become apparent to one skilled in the art after reading the present disclosure may be provided by the module 302.

At least some of the touch data may be transformed into one or more touch vectors. Accordingly, any processing on touch data described herein may equivalently be performed on corresponding touch vectors without straying from the spirit and scope of the present application. A touch vector characterizes one or more characteristics of the touch data such as length of touch, how many touches per unit time, orientation of a finger touching the touch sensor(s) (e.g., using known techniques), how far the product was moved during the touch, etc.

Information about the product and sales information corresponding to the product are transformed into product vector (feature vector) information used by the hierarchical multilabel classification system 304.

Product vector information may also be provided by the data module 302. Product vector information may include one or more feature vectors representing any information about a product, such as an identification of the product, predefined class of the product, price of the product, location of the product (e.g., shelf, shop and/or geographical information), frequency of sales of the product, number of products sold (e.g., per unit time, for all time, per store, etc.), which type of customer is actually purchasing these products, etc.

A hierarchical multilabel classification system 304 performs classification on the data from the data module 302. Artificial intelligence and/or machine learning techniques known in the art but trained specifically according to the teachings herein may be used.

A preferred embodiment performs classification of at least the touch data using a per level classifier 306 that operates on each level of the classifier 306 with hierarchical multilabel classification to assign at least the touch data to one or more predefined patterns for each level of the classifier 306, based on the information provided by the data module 302. In the example shown, a two level classifier is used to create a first level of outputs corresponding to patterns 308-318 and a second level of outputs corresponding to patterns 320.

Preferably, each level is allocated to a classifier of any desired type, such as detection trees, support vector machine, random forest, linear regression, etc. to dynamically assign inputs from the data module 302 to specific patterns.

Preferably, the hierarchical multilabel classification system 304 uses an already-trained classifier 306.

In other approaches, the classifier 306 may be trained using labeled training data corresponding to the desired outputs. For example, the classifier 306 may be deployed in a trained state as a trained Artificial Intelligence (AI) model. Training of the AI model, in some approaches, may be performed by applying a predetermined training data set to learn how to process the data from data module 302. Initial training may include reward feedback that may, in some approaches, be implemented using a subject matter expert (SME) that understands how the data from the hierarchical multilabel classification system 304 should be processed with respect to the training data. In another approach, the reward feedback may be implemented using techniques for training a Bidirectional Encoder Representations from Transformers (BERT) model, as would become apparent to one skilled in the art after reading the present disclosure. Once a determination is made that the AI model has achieved a redeemed threshold of accuracy during this training, a decision that the model is trained and ready to deploy for use in the hierarchical multilabel classification system 304 is made.

In some approaches, the hierarchical multilabel classification system 304 receives aggregated data from the data module 302 and performs classification. In other approaches, the hierarchical multilabel classification system 304 receives data over time, e.g., in real time, periodically, etc.

Preferably, the hierarchical multilabel classification system 304 operates on data from the data module 302 collected over the course of weeks or months, e.g., at least four weeks, more preferably at least twelve weeks, and ideally at least six months to more accurately recognize the patterns.

In some approaches, the hierarchical multilabel classification system 304 updates the patterns as new data is received, thereby improving the results of the classification. In preferred embodiments, the hierarchical multilabel classification system 304 may continuously perform classification as new data is received.

The output of the hierarchical multilabel classification system 304 includes several patterns 308-318, 320 per level that characterize the information provided by the data module 302.

Data assigned to the time pattern 308 may correspond to data following time-related patterns such as how many touches per unit time, which days get more touches, which times of day or month get more touches, etc. As shown, data classified to the time pattern 308 may be further classified, using a second level of the classifier, into time period data corresponding to time period patterns 320, such as daily, weekly, monthly, quarterly, etc. Further granularity may be provided by adding additional levels to the classifier.

Data assigned to the influential pattern 310 may correspond to which influencing factors are most likely to be relevant to why a product is being sold or not sold, etc. For example, the data may identify which product vectors correlate to the most touches, higher or lower sales of the product, etc.

Data assigned to the impulsive pattern 312 may provide information about impulsive buying patterns, e.g., based on low touch time before a purchase. Exemplary data may correspond to which product vector information correlates to more impulse buying behavior (e.g., which product features cause faster sales), etc.

Data assigned to the recommended pattern 314 may be used to derive recommendations for increasing sales of the product, e.g., by correlating product features with higher or lower touch vectors, by correlating product placement with higher or lower touch vectors, etc.

Data assigned to the buy vs. touch pattern 316 may be used to characterize customer touch behavior when a product is actually sold vs. touch patterns where the product is merely being examined.

Data assigned to the research decision pattern 318 may correlate customer touch behavior with the likelihood that the customer is merely researching the product based on whether they touch a product for a long time or more frequently before purchasing, e.g., because they are researching and/or investigating the product before making a decision to purchase, vs. behavior of customers who more quickly purchase the product.

Any other pattern that would become apparent to one skilled in the art after reading the present disclosure may be used and/or output by the hierarchical multilabel classification system 304.

The results of the classification are output. Preferably, the classified touch data and an indication of the pattern 308-320 to which the touch data is assigned are output, preferably in machine readable and/or human readable form, for use in any manner that would become apparent to one skilled in the art after reading the present disclosure.

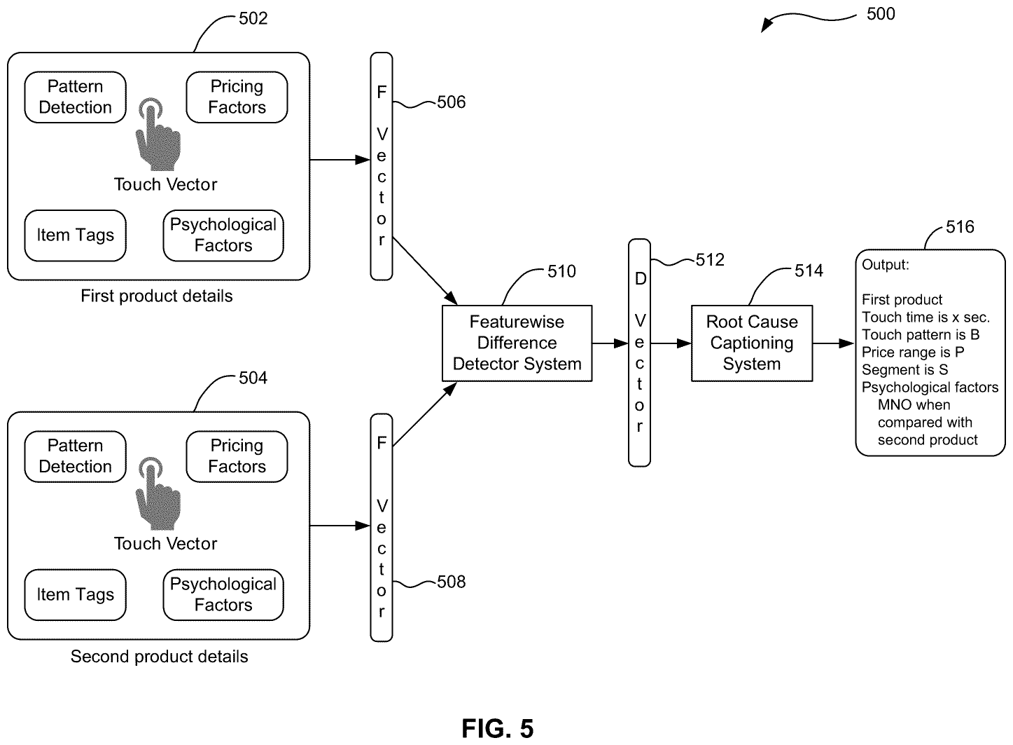

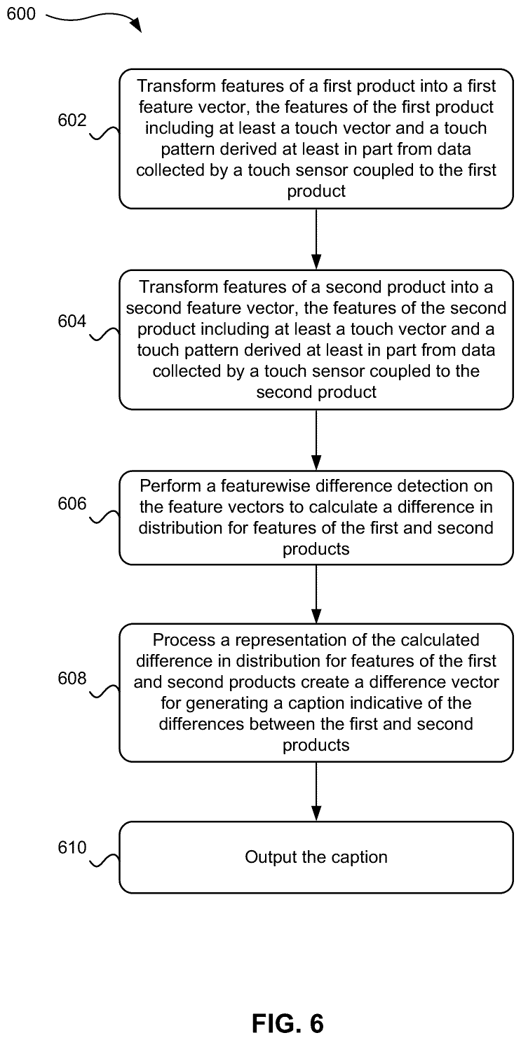

Preferably, the classified touch data and/or patterns are used for root cause analysis to determine why a product is or is not selling, e.g., at least a minimum number of units per unit time, relative to a similar product, etc. In such case, the result of the root cause analysis is output, e.g., as a caption. A preferred use of patterns is described with relation to FIGS. 5-6. Accordingly, as noted above, the method 400 may include one or more of the operations of FIG. 6, in some embodiments.

Based on the result of the root cause analysis, some characteristic of the product, from which the product vector information was derived in part, may be changed in an effort to increase sales of the product. Preferably, the classified touch data and/or patterns is analyzed to recommend a change to a characteristic of the product from which the product vector information is derived.

Note also that a human may review some of the resulting patterns and provide feedback to the hierarchical multilabel classification system 304 and/or for updating of the classifier 306 to improve the classification. Such input may include confirmation of a correct pattern classification, correction of an incorrect pattern classification, etc.

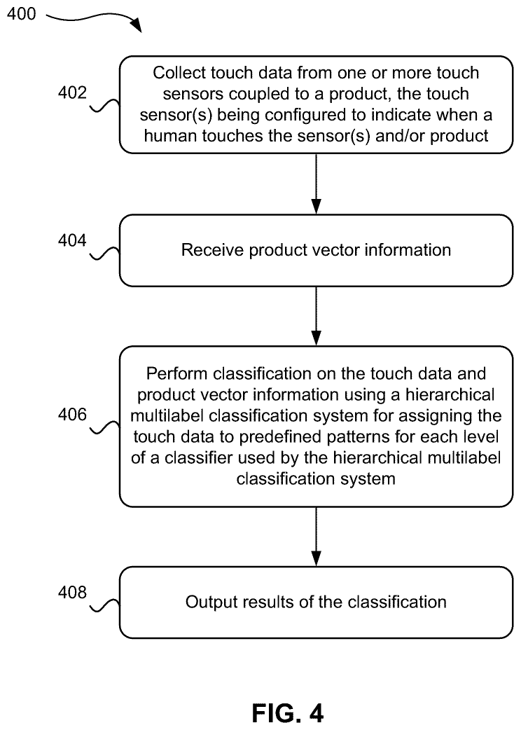

Now referring to FIG. 4, a flowchart of a method 400 that may be performed by the system 300 of FIG. 3 is shown, according to one embodiment. Note that the method 400 may be performed in accordance with the present invention in any of the environments depicted in FIGS. 1-3, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, in which touch data is collected from one or more touch sensors coupled to a product, the touch sensor(s) being configured to indicate when a human touches the sensor(s) and/or product.

In operation 404, product vector information about the product is received.

In operation 406, classification on the touch data and product vector information is performed using a hierarchical multilabel classification system for assigning the touch data to predefined patterns for each level of a classifier used by the hierarchical multilabel classification system.

In operation 408, the results of the classification are stored in a hardware memory. Exemplary results may include which patterns were identified, the touch data and the pattern to which assigned, etc.

The results are usable for a variety of purposes. In preferred embodiments, the patterns identified in the results are used in conjunction with the system and method of FIGS. 5 and 6, respectively.

FIG. 5 depicts a system 500 for performing root cause analytics for a product, in accordance with one embodiment. As an option, the present system 500 may be implemented in conjunction with features from any other embodiment listed herein, such as those described with reference to the other FIGS. Of course, however, such system 500 and others presented herein may be used in various applications and/or in permutations which may or may not be specifically described in the illustrative embodiments listed herein. Further, the system 500 presented herein may be used in any desired environment.

The system 500 may be configured to perform any type of analysis that compares features of multiple products in relation to consumer behavior. In the example below, the system 500 is configured to perform root cause analytics for determining why a product sells better than another similar product, using a correlation to consumer behavior.

As shown, a collection of first product features 502 correspond to a first product that is not selling as well as a second product. Similarly, a collection of second product features 504 correspond to the second product. The features 502, 504 may be of any type that would become apparent to one skilled in the art after reading the present disclosure. Each collection preferably includes similar types of features. In the example shown, each collection includes pattern detection feature(s) (e.g., as derived by the pattern detection system described above), touch vector feature(s) (e.g., as previously described), pricing factors, item tag feature(s) (e.g., characteristics of the product, such as its labeling, location, etc.), and psychological factor feature(s) (such as a characterization of why a consumer is more or less apt to purchase the product based on prior research or polling, why a customer is not spending much time with a product, etc.).

The product features 502, 504 are transformed into a respective feature vector 506, 508 (or series of vectors) using any known technique adapted for creating a feature vector. For example, a hashing algorithm may be used.

A featurewise difference detector system 510 performs a featurewise difference detection to calculate the difference in distribution for features of the first and second products, preferably for each feature thereof. Preferably, the featurewise difference detector system 510 calculates a difference between each and every feature from the product details. For example, the differences between a pricing factor of the first product and the pricing factor of the second product may be determined. The output may include a representation, e.g., a numerical difference between each feature, e.g., in the form of a difference vector 512.

A root cause captioning system 514 processes the output of the featurewise difference detector system 510 to determine captions that characterize why the first product is not selling as well as the second product. The root cause captioning system 514 may include any type of processing configuration that provides the desired output caption 516. In a preferred approach, the root cause captioning system 514 includes a neural network such as a recurrent neural network (RNN). The RNN may be trained with inferences. For example, impulsive buyers tend to buy products with little or no research and so tend to have short touch spans. In contrast, researching buyers tend to perform more research before buying, and consequently tend to have relatively longer touch spans.

The output caption 516 may be presented in any format desired, e.g., in computer readable form, in human readable form, etc. An example of such output is presented in FIG. 5. Preferably, the caption is further used to compute a recommended change to a characteristic of the first product.

Now referring to FIG. 6, a flowchart of a method 600 that may be performed by the system 500 of FIG. 5 is shown, according to one embodiment.

Note that the method 600 may be performed in accordance with the present invention in any of the environments depicted in FIGS. 1-5, among others, in various embodiments. Of course, more or fewer operations than those specifically described in FIG. 6 may be included in method 600, as would be understood by one of skill in the art upon reading the present descriptions.

Preferably, the method 600 may be performed using the patterns and other information derived in the processes shown in FIGS. 3-4 and related description.

Each of the steps of the method 600 may be performed by any suitable component of the operating environment. For example, in various embodiments, the method 600 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 includes operation 602, in which features of a first product are transformed into a first feature vector, the features of the first product including at least a touch vector and a touch pattern derived at least in part from data collected by a touch sensor coupled to the first product.

In operation 604, features of a second product are transformed into a second feature vector, the features of the second product including at least a touch vector and a touch pattern derived at least in part from data collected by a touch sensor coupled to the second product;

In operation 606, a featurewise difference detection is performed on the feature vectors to calculate a difference in distribution for features of the first and second products;

In operation 608, a representation of the calculated difference in distribution for features of the first and second products is processed to create a difference vector for generating a caption indicative of the differences between the first and second products; and

In operation 610, the caption is output.

### Benefits and Practical Applications

The foregoing methodologies provide many practical applications. For example, as noted above, by determining patterns of touch as derived from touch sensor data, knowledge about actual physical consumer touch-based interaction with a product can be determined, thereby enabling better decisionmaking for things like pricing, displaying, etc. Moreover, the captions generated as described herein can be used to improve product features, placement, timing, etc. to improve sales thereof.

Moreover, by assessing touch data across weeks or months, better decisions can be made about increasing or decreasing warehousing, stocking, etc. Such long term assessment would be impractical to perform in the human mind.

The foregoing methodologies, while rooted in system diagnosis, convey an improvement in another technology, namely product management, by improving the ability to make better decisions regarding product improvement, stocking and warehousing, etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
collecting touch data from one or more touch sensors coupled to a first product, the one or more touch sensors being configured to indicate when a human touches the one or more touch sensors and/or first product;
receiving product vector information about the first product;
performing classification on the touch data and product vector information using a hierarchical multilabel classification system for assigning the touch data to predefined patterns for each level of a classifier used by the hierarchical multilabel classification system;
transforming features of the first product into a first feature vector, the features of the first product including the patterns;
transforming features of a second product into a second feature vector, the features of the second product including at least a touch vector and a touch pattern derived at least in part from data collected by a touch sensor coupled to the second product;
performing a featurewise difference detection on the feature vectors to calculate a difference in distribution for features of the respective products;
processing a representation of the calculated difference in distribution for features of the products to create a difference vector for generating a caption indicative of the differences between the products; and
outputting the caption.

2. The computer-implemented method of claim 1, wherein the patterns include at least two patterns selected from the group consisting of: a time pattern, an influential pattern, an impulsive pattern, a recommended pattern, a buy vs. touch pattern, and a research decision pattern.

3. The computer-implemented method of claim 1, wherein the product vector information includes one or more feature vectors representing information about the first product, the information being selected from the group consisting of: identification of the first product, class of the first product, price of the first product, location of the first product, frequency of sales of the first product, and number of the first product sold.

4. The computer-implemented method of claim 1, wherein processing the representation of the calculated difference comprises using the patterns to perform root cause analytics to determine why the first product is not selling; and wherein the caption includes computed reasons why the first product is not selling.

5. The computer-implemented method of claim 4, comprising using the caption to recommend a change to a characteristic of the first product.

6. The computer-implemented method of claim 1, wherein the features of the first and second products include pricing factor features and item tag features.

7. The computer-implemented method of claim 1, comprising determining an orientation of a finger touching the one or more touch sensors; and transforming the orientation of the finger into a touch vector.

8. A computer program product, the computer program product comprising a computer readable storage medium having program instructions embodied therewith, the program instructions executable by a computer to cause the computer to:
collect, by the computer, touch data from one or more touch sensors coupled to a first product, the one or more touch sensors being configured to indicate when a human touches the one or more touch sensors and/or first product;
receive, by the computer, product vector information about the first product;
perform, by the computer, classification on the touch data and product vector information using a hierarchical multilabel classification system for assigning the touch data to predefined patterns for each level of a classifier used by the hierarchical multilabel classification system;
transform, by the computer, features of the first product into a first feature vector, the features of the first product including the patterns;
transform, by the computer, features of a second product into a second feature vector, the features of the second product including at least a touch vector and a touch pattern derived at least in part from data collected by a touch sensor coupled to the second product;
perform, by the computer, a featurewise difference detection on the feature vectors to calculate a difference in distribution for features of the respective products;
process, by the computer, a representation of the calculated difference in distribution for features of the products to create a difference vector for generating a caption indicative of the differences between the products; and
output, by the computer, the caption.

9. The computer program product of claim 8, wherein the patterns include at least two patterns selected from the group consisting of: a time pattern, an influential pattern, an impulsive pattern, a recommended pattern, a buy vs. touch pattern, and a research decision pattern.

10. The computer program product of claim 8, wherein the product vector information includes one or more feature vectors representing information about the first product, the information being selected from the group consisting of:
identification of the first product, class of the first product, price of the first product, location of the first product, frequency of sales of the first product, and number of the first product sold.

11. The computer program product of claim 8, wherein processing the representation of the calculated difference comprises using the patterns to perform root cause analytics to determine why the first product is not selling; and wherein the caption includes computed reasons why the first product is not selling.

12. The computer program product of claim 8, comprising program instructions executable by the computer to cause the computer to use the caption to recommend a change to a characteristic of the product.

13. The computer program product of claim 8, wherein the features of the first and second products include pricing factor features and item tag features.

14. The computer program product of claim 8, comprising program instructions executable by the computer to cause the computer to determine an orientation of a finger touching the one of one or more touch sensors; and transform the orientation of the finger into a touch vector.

15. A system, comprising:
a hardware processor; and
logic integrated with the processor, executable by the processor, or integrated with and executable by the processor, the logic being configured to:
collect touch data from one or more touch sensors coupled to a first product, the one or more touch sensors being configured to indicate when a human touches the one or more touch sensors and/or first product;
receive product vector information about the first product;
perform classification on the touch data and product vector information using a hierarchical multilabel classification system for assigning the touch data to predefined patterns for each level of a classifier used by the hierarchical multilabel classification system;
transform features of the product into a first feature vector, the features of the product including the patterns;
transform features of a second product into a second feature vector, the features of the second product including at least a touch vector and a touch pattern derived at least in part from data collected by a touch sensor coupled to the second product;
perform a featurewise difference detection on the feature vectors to calculate a difference in distribution for features of the respective products;
process a representation of the calculated difference in distribution for features of the products to create a difference vector for generating a caption indicative of the differences between the products; and
output the caption.

16. The system of claim 15, wherein the patterns include at least two patterns selected from the group consisting of: a time pattern, an influential pattern, an impulsive pattern, a recommended pattern, a buy vs. touch pattern, and a research decision pattern.

17. The system of claim 15, wherein the product vector information includes one or more feature vectors representing information about the first product, the information being selected from the group consisting of: identification of the first product, class of the first product, price of the first product, location of the first product, frequency of sales of the first product, and number of the first product sold.

18. The system of claim 15, wherein processing the representation of the calculated difference comprises using the patterns to perform root cause analytics to determine why the first product is not selling; and wherein the caption includes computed reasons why the identification of the first product, class of the first product, price of the first product, location of the first product, frequency of sales of the first product, and number of the first product is not selling.

19. The system of claim 15, comprising logic configured to use the caption to recommend a change to a characteristic of the first product.

20. The system of claim 15. comprising logic configured to determine an orientation of a finger touching the one or more touch sensors; and transform the orientation of the finger into a touch vector.
